(19) United States
(12) Patent Application Publication
(10) Pub. No.: US 2018/0354342 A1
(43) Pub. Date: Dec. 13, 2018

(54) Vehicle Air Conditioning Device

(71) Applicant: SANDEN AUTOMOTIVE CLIMATE SYSTEMS CORPORATION, Isesaki-shi (JP)

(72) Inventors: Ryo MIYAKOSHI, Isesaki-shi (JP); Kenichi SUZUKI, Isesaki-shi (JP); Kohei YAMASHITA, Isesaki-shi (JP)

(21) Appl. No.: 15/579,821

(22) PCT Filed: Jun. 1, 2016
(86) PCT No.: PCT/JP2016/066114

§ 371 Date: Dec. 5, 2017

(30) Foreign Application Priority Data
Jun. 25, 2015 (JP) 2015-127497

(51) Int. Cl. B60H 1/00; B60H 1/32

(52) U.S. Cl. CPC B60H 1/00921; F25B 1/00; B60H 1/3207; B60H 1/3213

(57) ABSTRACT

Vehicle air conditioning device executes the dehumidifying mode in which a controller lets refrigerant discharged from compressor 2 radiate heat in radiator 4, decompresses the refrigerant from which heat has been radiated and then lets the refrigerant absorb heat in heat absorber 9 and outdoor heat exchanger 7, or lets the refrigerant discharged from compressor 2 radiate heat in radiator 4 and outdoor heat exchanger 7, decompresses the refrigerant from which heat has been radiated and then lets the refrigerant absorb heat in heat absorber 9. In the dehumidifying mode, the controller executes simple control to compare a target value of an index that is a basis of control of the outdoor expansion valve with an actual detected value and to change a valve position of the outdoor expansion valve from a magnitude relation between the value in an enlarging direction or a reducing direction as much as a constant value.

### TECHNICAL FIELD

The present invention relates to a vehicle air conditioning device of a heat pump system which conditions air of a vehicle interior, and more particularly, it relates to a vehicle air conditioning device which is applicable to a hybrid car or an electric vehicle.

### BACKGROUND ART

Due to actualization of environmental problems in recent years, hybrid cars and electric vehicles have spread. Further, as an air conditioning device which is applicable to such a vehicle, there has been developed an air conditioning device which includes a compressor to compress and discharge a refrigerant, a radiator disposed on a vehicle interior side to let the refrigerant radiate heat, a heat absorber disposed on the vehicle interior side to let the refrigerant absorb heat, and an outdoor heat exchanger disposed outside the vehicle interior to let the refrigerant radiate heat or absorb heat, and in which there are changeable a heating mode to let the refrigerant discharged from the compressor radiate heat in the radiator and let the refrigerant from which the heat has been radiated in this radiator absorb heat in the outdoor heat exchanger, a dehumidifying and heating mode to let the refrigerant discharged from the compressor radiate heat in the radiator and let the refrigerant from which the heat has been radiated in the radiator absorb heat only in the heat absorber or in this heat absorber and the outdoor heat exchanger, a cooling mode to let the refrigerant discharged from the compressor radiate heat in outdoor heat exchanger and let the refrigerant absorb heat in the heat absorber, and a dehumidifying and cooling mode to let the refrigerant discharged from the compressor radiate heat in the radiator and the outdoor heat exchanger and let the refrigerant absorb heat in the heat absorber.

In this case, an outdoor expansion valve is provided in an inlet of the outdoor heat exchanger, and in the above-mentioned heating mode or dehumidifying and heating mode, the refrigerant flowing into the outdoor heat exchanger is decompressed by this outdoor expansion valve. Then, in the heating mode, a control amount of the outdoor expansion valve is calculated on the basis of a target subcool degree that is a target value of a subcool degree of the refrigerant in an outlet of the radiator, and an actual subcool degree and a valve position of the outdoor expansion valve is finely adjusted, thereby controlling the subcool degree to the target subcool degree (PI control or the like).

Furthermore, in the dehumidifying and heating mode, the refrigerant flowing out from the radiator is distributed, one refrigerant is decompressed and flows into the heat absorber to let the refrigerant absorb heat in the heat absorber, and the other refrigerant is decompressed by the outdoor expansion valve and flows into the outdoor heat exchanger to let the refrigerant absorb heat, but in this case, the control amount of the outdoor expansion valve is calculated on the basis of a target heat absorber temperature that is a target value of a temperature of the heat absorber and an actual heat absorber temperature, thereby finely controlling the valve position of the outdoor expansion valve.

Further in the dehumidifying and cooling mode, the control amount of the outdoor expansion valve is calculated on the basis of a target radiator pressure that is a target value of a pressure (a high pressure-side pressure) of the radiator and an actual radiator pressure, thereby finely controlling the valve position of the outdoor expansion valve (e.g., see Patent Document 1).

### CITATION LIST

### Patent Document

Patent Document 1: Japanese Patent Application Publication No. 2014-94673

### SUMMARY OF THE INVENTION

### Problems to be Solved by the Invention

Here, in the above-mentioned heating mode, a refrigerant flow rate of a radiator is limited by a valve position of an outdoor expansion valve to provide a subcool degree of a refrigerant in an outlet of the radiator, and hence change of the subcool degree by change of the valve position of the outdoor expansion valve is comparatively large (a sensitivity is high).

However, in the above-mentioned dehumidifying and heating mode, a ratio of flow rates of refrigerants flowing into the outdoor heat exchanger and a heat absorber (a distribution ratio of the refrigerants) is changed in accordance with the valve position of the outdoor expansion valve, and hence change of a heat absorber temperature by the change of the valve position of the outdoor expansion valve is comparatively small (the sensitivity is low). Furthermore, in the above-mentioned dehumidifying and cooling mode, the valve position of the outdoor expansion valve is originally controlled to be slightly large, and hence change of a radiator pressure by the change of the valve position of the outdoor expansion valve similarly comparatively decreases (the sensitivity is low).

On the other hand, in a system of calculating a control amount of the outdoor expansion valve to finely control the valve position, an energization rate to a coil of the outdoor expansion valve increases, and hence temperature rise or durability of the outdoor expansion valve itself causes problems. Furthermore, feedback logic of PI control, PID control or the like is required, control logic therefore becomes complicated, and there also occurs the problem that the possibility of inducing disadvantages heightens.

The present invention has been developed to solve such conventional technical problems, and an object thereof is to provide a vehicle air conditioning device which is capable of avoiding disadvantages such as temperature rise and durability deterioration of an outdoor expansion valve while acquiring controllability in a dehumidifying mode of dehumidifying and heating, dehumidifying and cooling, or the like.

### Means for Solving the Problems

A vehicle air conditioning device of the present invention includes a compressor to compress a refrigerant, an air flow passage through which air to be supplied to a vehicle interior flows, a radiator disposed in this air flow passage to let the refrigerant radiate heat, a heat absorber disposed in the air flow passage to let the refrigerant absorb heat, an outdoor heat exchanger disposed outside the vehicle interior to let the refrigerant radiate heat or absorb heat, an outdoor expansion valve to decompress the refrigerant flowing out from the radiator and let the refrigerant flow into the outdoor heat exchanger, and a control means, so that the control means is configured to change and execute at least a heating mode in which the control means lets the refrigerant discharged from the compressor radiate heat in the radiator, decompresses the refrigerant from which the heat has been radiated, and then lets the refrigerant absorb heat in the outdoor heat exchanger, and at least a dehumidifying mode in which the control means lets the refrigerant discharged from the compressor radiate heat in the radiator, decompresses the refrigerant from which the heat has been radiated, and then lets the refrigerant absorb heat in the heat absorber, and the vehicle air conditioning device is characterized in that in the dehumidifying mode, the control means executes simple control to compare a target value of an index that is a basis of control of the outdoor expansion valve with an actual detected value and to change a valve position of the outdoor expansion valve from a magnitude relation between the values in an enlarging direction or a reducing direction as much as a constant value.

The vehicle air conditioning device of the invention of claim 2 is characterized in that in the above invention, in the heating mode, the control means calculates a control amount of the outdoor expansion valve on the basis of a target subcool degree that is a target value of a subcool degree of the refrigerant in an outlet of the radiator and an actual subcool degree, and controls the subcool degree to the target subcool degree.

The vehicle air conditioning device of the invention of claim 3 is characterized in that in the above respective inventions, the dehumidifying mode has a dehumidifying and heating mode in which the control means lets the refrigerant discharged from the compressor radiate heat in the radiator, distributes the refrigerant from which the heat has been radiated, decompresses one refrigerant and then lets the refrigerant absorb heat in the heat absorber, and decompresses the other refrigerant by the outdoor expansion valve and then lets the refrigerant absorb heat in the outdoor heat exchanger, and in the dehumidifying and heating mode, the control means employs a heat absorber temperature as the index, changes the valve position of the outdoor expansion valve in the enlarging direction as much as the constant value when an actually detected heat absorber temperature is lower than a target heat absorber temperature that is a target value of the heat absorber temperature, and changes the valve position of the outdoor expansion valve in the reducing direction as much as the constant value when the heat absorber temperature is higher than the target heat absorber temperature.

The vehicle air conditioning device of the invention of claim 4 is characterized in that in the above invention, the control means adjusts the valve position of the outdoor expansion valve to an upper limit of a control range when the heat absorber temperature is lower than the target heat absorber temperature, and adjusts the valve position of the outdoor expansion valve to a lower limit of the control range when the heat absorber temperature is higher than the target heat absorber temperature.

The vehicle air conditioning device of the invention of claim 5 is characterized in that in the invention of claim 3, the control means compares the target heat absorber temperature with the heat absorber temperature, and changes the valve position of the outdoor expansion valve from a magnitude relation between the temperatures in the enlarging direction or the reducing direction stepwisely in the control range.

The vehicle air conditioning device of the invention of claim 6 includes, in the inventions of claim 3 to claim 5, an evaporation capability control valve disposed on a refrigerant outlet side of the heat absorber to adjust an evaporation capability of the refrigerant in the heat absorber, and is characterized in that the control means executes heat absorber evaporation capability control by adjustment of a valve position of the evaporation capability control valve, when a state where the heat absorber temperature is lower than the target heat absorber temperature continues for a predetermined time, although the valve position of the outdoor expansion valve indicates the upper limit of the control range.

The vehicle air conditioning device of the invention of claim 7 is characterized in that in the above respective inventions, the dehumidifying mode has a dehumidifying and cooling mode in which the control means lets the refrigerant discharged from the compressor radiate heat in the radiator and the outdoor heat exchanger, decompresses the refrigerant from which the heat has been radiated, and then lets the refrigerant absorb heat in the heat absorber, and in this dehumidifying and cooling mode, the control means employs a radiator pressure as the index, changes the valve position of the outdoor expansion valve in the reducing direction as much as the constant value when an actually detected radiator pressure is lower than a target radiator pressure that is a target value of the radiator pressure, and changes the valve position of the outdoor expansion valve in the enlarging direction as much as the constant value when the radiator pressure is higher than the target radiator pressure.

The vehicle air conditioning device of the invention of claim 8 is characterized in that in the above invention, the control means compares the target radiator pressure with the radiator pressure, and changes the valve position of the outdoor expansion valve from a magnitude relation between the pressures in the enlarging direction or the reducing direction stepwisely in the control range.

The vehicle air conditioning device of the invention of claim 9 is characterized in that in the invention of claim 7 or claim 8, in the dehumidifying and cooling mode, the control means controls a capability of the compressor on the basis of the heat absorber temperature, and executes radiator temperature priority control to increase the capability of the compressor, when a state where the radiator pressure is lower than the target radiator pressure continues for a predetermined time, although the valve position of the outdoor expansion valve indicates the lower limit of the control range.

The vehicle air conditioning device of the invention of claim 10 is characterized in that in the above respective inventions, the control means determines an operating width and an operation standby time of the outdoor expansion valve in a range to inhibit control hunting of the outdoor expansion valve and to prevent abnormal heating.

### Advantageous Effect of the Invention

According to the present invention, a vehicle air conditioning device includes a compressor to compress a refrigerant, an air flow passage through which air to be supplied to a vehicle interior flows, a radiator disposed in this air flow passage to let the refrigerant radiate heat, a heat absorber disposed in the air flow passage to let the refrigerant absorb heat, an outdoor heat exchanger disposed outside the vehicle interior to let the refrigerant radiate heat or absorb heat, an outdoor expansion valve to decompress the refrigerant flowing out from the radiator and let the refrigerant flow into the outdoor heat exchanger, and a control means, so that the control means is configured to change and execute at least a heating mode in which control means lets the refrigerant discharged from the compressor radiate heat in the radiator, decompresses the refrigerant from which the heat has been radiated, and then lets the refrigerant absorb heat in the outdoor heat exchanger, and at least a dehumidifying mode in which the control means lets the refrigerant discharged from the compressor radiate heat in the radiator, decompresses the refrigerant from which the heat has been radiated, and then lets the refrigerant absorb heat in the heat absorber, and in the vehicle air conditioning device, in the dehumidifying mode, the control means executes simple control to compare a target value of an index that is a basis of control of the outdoor expansion valve with an actual detected value and to change a valve position of the outdoor expansion valve from a magnitude relation between the values in an enlarging direction or a reducing direction as much as a constant value. Consequently, as in the invention of claim 2, in the heating mode, the control means calculates a control amount of the outdoor expansion valve on the basis of a target subcool degree that is a target value of a subcool degree of the refrigerant in an outlet of the radiator and an actual subcool degree, and finely controls the valve position of the outdoor expansion valve to control the subcool degree to the target subcool degree. Also in this case, in the dehumidifying mode, the control means executes the simple control to the outdoor expansion valve to compare the target value of the index that is the basis of the control of the outdoor expansion valve with the actual detected value and to change the valve position from the magnitude relation between the values in the enlarging direction or the reducing direction as much as the constant value.

For example, as in the invention of claim 3, in the case of executing, as one of the dehumidifying modes, a dehumidifying and heating mode in which the control means lets the refrigerant discharged from the compressor radiate heat in the radiator, distributes the refrigerant from which the heat has been radiated, decompresses one refrigerant and then lets the refrigerant absorb heat in the heat absorber, and decompresses the other refrigerant by the outdoor expansion valve and then lets the refrigerant absorb heat in the outdoor heat exchanger, the control means employs a heat absorber temperature as the index, changes the valve position of the outdoor expansion valve in the enlarging direction as much as the constant value when an actually detected heat absorber temperature is lower than a target heat absorber temperature that is a target value of the heat absorber temperature, and changes the valve position of the outdoor expansion valve in the reducing direction as much as the constant value when the heat absorber temperature is higher than the target heat absorber temperature.

Furthermore, for example, as in the invention of claim 7, in the case of executing, as one of the dehumidifying modes, a dehumidifying and cooling mode in which the control means lets the refrigerant discharged from the compressor radiate heat in the radiator and the outdoor heat exchanger, decompresses the refrigerant from which the heat has been radiated, and then lets the refrigerant absorb heat in the heat absorber, the control means employs a radiator pressure as the index, changes the valve position of the outdoor expansion valve in the reducing direction as much as the constant value when an actually detected radiator pressure is lower than a target radiator pressure that is a target value of this radiator pressure, and changes the valve position of the outdoor expansion valve in the enlarging direction as much as the constant value when the radiator pressure is higher than the target radiator pressure. Consequently, in any dehumidifying mode, it is possible to avoid such fine control of the valve position as in the heating mode of the invention of claim 2 and to avoid disadvantages such as temperature rise and durability deterioration of the outdoor expansion valve, while acquiring controllability of the vehicle air conditioning device. Furthermore, it is also possible to noticeably simplify control logic, and hence generation of the disadvantages is also inhibited.

Here, in the dehumidifying and heating mode, as in the invention of claim 4, the control means adjusts the valve position of the outdoor expansion valve to an upper limit of a control range when the heat absorber temperature is lower than the target heat absorber temperature, and adjusts the valve position of the outdoor expansion valve to a lower limit of the control range when the heat absorber temperature is higher than the target heat absorber temperature, so that it is possible to further simplify the control logic.

On the other hand, as in the invention of claim 5, the control means compares the target heat absorber temperature with the heat absorber temperature, and changes the valve position of the outdoor expansion valve from a magnitude relation between the temperatures in the enlarging direction or the reducing direction stepwisely in the control range, so that it is possible to inhibit deterioration of the controllability as much as possible.

Furthermore, as in the invention of claim 6, an evaporation capability control valve to adjust an evaporation capability of the refrigerant in the heat absorber is disposed on a refrigerant outlet side of the heat absorber. At this time, the control means executes heat absorber evaporation capability control by adjustment of a valve position of the evaporation capability control valve, when a state where the heat absorber temperature is lower than the target heat absorber temperature continues for a predetermined time, although the valve position of the outdoor expansion valve indicates the upper limit of the control range. Consequently, also when it is not possible to raise the heat absorber temperature by the valve position control of the outdoor expansion valve, the heat absorber temperature can be brought close to the target heat absorber temperature by the evaporation capability control valve.

Additionally, also in the dehumidifying and cooling mode of the invention of claim 7, when the control means compares the target radiator pressure with the radiator pressure, and changes the valve position of the outdoor expansion valve from a magnitude relation between the pressures in the enlarging direction or the reducing direction stepwisely in the control range as in the invention of claim 8, it is possible to inhibit the deterioration of the controllability as much as possible.

Furthermore, as the invention of claim 9, the control means controls a capability of the compressor on the basis of the heat absorber temperature in the dehumidifying and cooling mode, and executes radiator temperature priority control to increase the capability of the compressor, when a state where the radiator pressure is lower than the target radiator pressure continues for a predetermined time, although the valve position of the outdoor expansion valve indicates the lower limit of the control range. Consequently, also when it is not possible to raise the radiator pressure by the outdoor expansion valve, the control means increases the capability of the compressor to raise the radiator pressure by the radiator temperature priority control, so that the radiator pressure can come close to the target radiator pressure.

Then, the control means of the invention of claim 10 determines an operating width and an operation standby time of the outdoor expansion valve in a range to inhibit control hunting of the outdoor expansion valve and to prevent abnormal heating, so that it is possible to securely avoid the abnormal heating of the outdoor expansion valve while acquiring the controllability.

### BRIEF DESCRIPTION OF THE DRAWINGS

FIG. 1 is a constitutional view of a vehicle air conditioning device of one embodiment to which the present invention is applied;

FIG. 2 is a block diagram of an electric circuit of a controller of the vehicle air conditioning device of FIG. 1;

FIG. 3 is a control block diagram concerning outdoor expansion valve control in a heating mode by the controller of FIG. 2;

FIG. 4 is a transition diagram to explain outdoor expansion valve control in a dehumidifying and heating mode by the controller of FIG. 2;

FIG. 5 is a timing chart to explain a usual control mode of the outdoor expansion valve control of FIG. 4;

FIG. 6 is a timing chart to explain a heat absorber evaporation capability control mode of the outdoor expansion valve control of FIG. 4;

FIG. 7 is a control block diagram concerning compressor control in a dehumidifying and cooling mode by the controller of FIG. 2;

FIG. 8 is a timing chart to explain outdoor expansion valve control in the dehumidifying and cooling mode by the controller of FIG. 2;

FIG. 9 is a diagram to explain change control of a normal mode and a radiator temperature priority mode (radiator temperature priority control) in the dehumidifying and cooling mode by the controller of FIG. 2; and

FIG. 10 is a control block diagram of the controller in the radiator temperature priority mode of FIG. 9.

### MODE FOR CARRYING OUT THE INVENTION

Hereinafter, description will be made as to an embodiment of the present invention in detail with reference to the drawings.

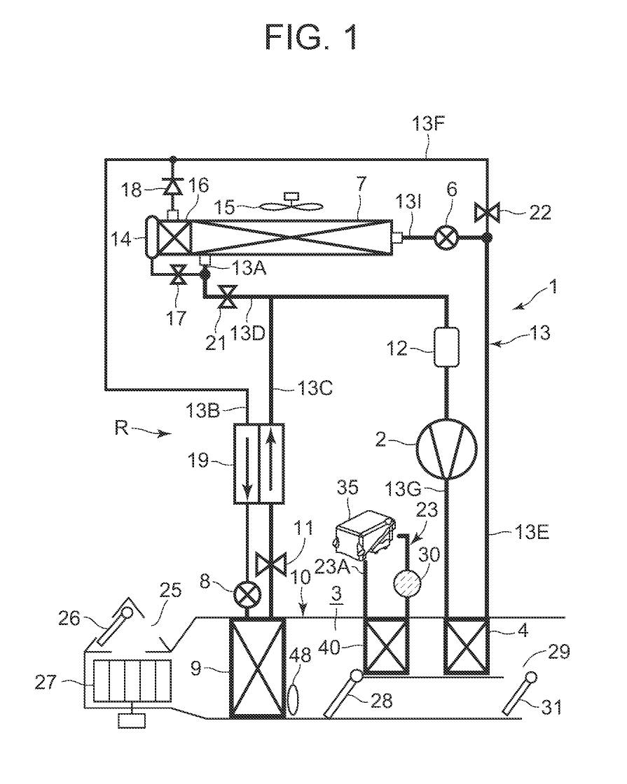

FIG. 1 shows a constitutional view of a vehicle air conditioning device 1 as one embodiment of a refrigerating apparatus of the present invention. In this case, a vehicle of the embodiment to which the present invention is applied is an electric vehicle (EV) which does not have an engine (an internal combustion engine), and runs with an electric motor for running which is driven by power charged in a battery (any of which is not shown in the drawing), and the vehicle air conditioning device 1 of the present invention is also driven by the power of the battery.

Specifically, in the electric vehicle which is not capable of performing heating by engine waste heat, the vehicle air conditioning device 1 of the embodiment performs heating by a heat pump operation in which a refrigerant circuit is used, and furthermore, the device selectively executes respective operation modes of dehumidifying and heating and dehumidifying and cooling (both include the dehumidifying), cooling and others. It is to be noted that the vehicle is not limited to the electric vehicle, and the present invention is also effective for a so-called hybrid car in which the engine is used together with the electric motor for running. Furthermore, the present invention is also applicable to a usual car which runs with the engine.

The vehicle air conditioning device 1 of the embodiment performs air conditioning (heating, cooling, dehumidifying, and ventilation) of a vehicle interior of the electric vehicle, and there are successively connected, by a refrigerant pipe 13, an electric type of compressor 2 which compresses a refrigerant to raise a pressure, a radiator 4 disposed in an air flow passage 3 of an HVAC unit 10 in which vehicle interior air passes and circulates, to let the high-temperature high-pressure refrigerant discharged from the compressor 2 radiate heat in the vehicle interior, an outdoor expansion valve (ECCV) 6 constituted of an electronic expansion valve which decompresses and expands the refrigerant during the heating, an outdoor heat exchanger 7 whose inlet is connected to a refrigerant pipe 131 extending out from the outdoor expansion valve 6 and which performs heat exchange between the refrigerant and outdoor air to function as the radiator during the cooling and to function as an evaporator during the heating, an indoor expansion valve 8 constituted of an electronic expansion valve to decompress and expand the refrigerant, a heat absorber 9 disposed in the air flow passage 3 to let the refrigerant absorb heat from interior and exterior of the vehicle during the cooling and during the dehumidifying and heating, an evaporation capability control valve 11 which adjusts an evaporation capability in the heat absorber 9, an accumulator 12, and others, thereby constituting a refrigerant circuit R.

In the evaporation capability control valve 11, its valve position is settable to a large position (OFF) and a small position (ON), and it is possible to adjust a flow rate of the refrigerant flowing through the heat absorber 9 in two stages. Furthermore, in the outdoor heat exchanger 7, an outdoor blower 15 is provided to perform the heat exchange between the outdoor air and the refrigerant during stopping of the vehicle. The outdoor heat exchanger 7 has a header portion 14 and a subcooling portion 16 successively on a refrigerant downstream side, a refrigerant pipe 13A extending out from the outdoor heat exchanger 7 is connected to the header portion 14 via a solenoid valve (an opening/closing valve) 17 to be opened during the cooling, and an outlet of the subcooling portion 16 is connected to the indoor expansion valve 8 via a check valve 18. It is to be noted that the header portion 14 and the subcooling portion 16 structurally constitute a part of the outdoor heat exchanger 7, and an indoor expansion valve 8 side of the check valve 18 is a forward direction.

Furthermore, a refrigerant pipe 13B between the check valve 18 and the indoor expansion valve 8 is disposed in a heat exchange relation with a refrigerant pipe 13C extending out from the evaporation capability control valve 11 positioned on an outlet side of the heat absorber 9, and both the pipes constitute an internal heat exchanger 19. In consequence, the refrigerant flowing into the indoor expansion valve 8 through the refrigerant pipe 13B is cooled (subcooled) by the low-temperature refrigerant flowing out from the heat absorber 9 through the evaporation capability control valve 11.

Additionally, the refrigerant pipe 13A extending out from the outdoor heat exchanger 7 branches, and this branching refrigerant pipe 13D communicates and connects with the refrigerant pipe 13C on a downstream side of the internal heat exchanger 19 via a solenoid valve (an opening/closing valve) 21 to be opened during the heating. In addition, a refrigerant pipe 13E on an outlet side of the radiator 4 branches before the outdoor expansion valve 6, and this branching refrigerant pipe 13F communicates and connects with the refrigerant pipe 13B on a downstream side of the check valve 18 via a solenoid valve (an opening/closing valve) 22 to be opened during the dehumidifying.

Furthermore, in the air flow passage 3 on an air upstream side of the heat absorber 9, respective suction ports such as an indoor air suction port and an outdoor air suction port are formed (represented by a suction port 25 in FIG. 1), and in the suction port 25, a suction changing damper 26 is disposed to change the air to be introduced into the air flow passage 3 to indoor air which is air of the vehicle interior (an indoor air circulating mode) and outdoor air which is air outside the vehicle interior (an outdoor air introducing mode). Furthermore, on an air downstream side of the suction changing damper 26, an indoor blower (a blower fan) 27 is disposed to supply the introduced indoor air or outdoor air to the air flow passage 3.

Further in FIG. 1, reference numeral 23 denotes a heating medium circulating circuit as auxiliary heating means provided in the vehicle air conditioning device 1 of the embodiment. The heating medium circulating circuit 23 includes a circulating pump 30 constituting circulating means, a heating medium heating electric heater 35, and a heating medium-air heat exchanger 40 disposed in the air flow passage 3 on an air upstream side of the radiator 4 to flow of air of the air flow passage 3, and these components are successively annularly connected to one another by a heating medium pipe 23A. It is to be noted that as a heating medium to circulate in the heating medium circulating circuit 23, for example, water, a refrigerant such as HFO-1234yf, a coolant or the like is employed.

Thus, when the circulating pump 30 is operated and the heating medium heating electric heater 35 is energized to heat, the heating medium heated by the heating medium heating electric heater 35 circulates through the heating medium-air heat exchanger 40. That is, the heating medium-air heat exchanger 40 of the heat exchanger circulating circuit 23 becomes a so-called heater core, to complement the heating of the vehicle interior. The employing of the heating medium circulating circuit 23 improves electric safety of passengers.

Furthermore, in the air flow passage 3 on the air upstream side of the heating medium-air heat exchanger 40 and the radiator 4, an air mix damper 28 is disposed to adjust a degree at which the indoor air or outdoor air passes through the radiator 4. Further in the air flow passage 3 on the air downstream side of the radiator 4, there is formed each outlet (represented by an outlet 29 in FIG. 1) of foot, vent or defroster, and in the outlet 29, an outlet changing damper 31 is disposed to execute changing control of blowing of the air from each outlet mentioned above.

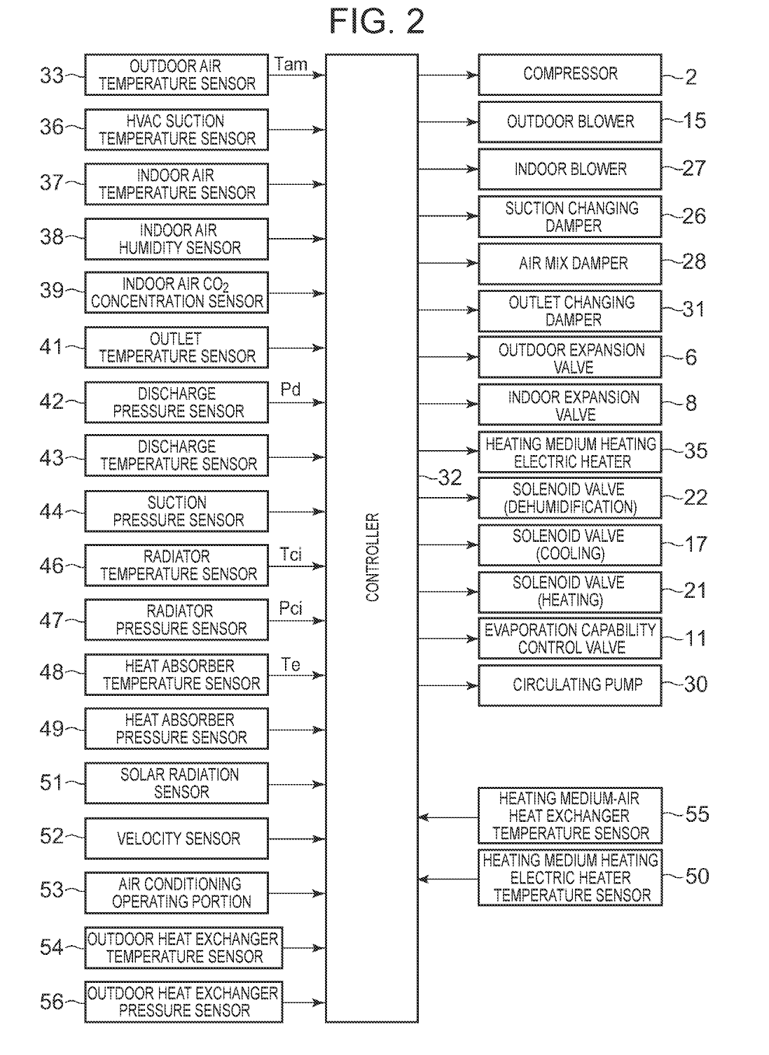

Next, in FIG. 2, 32 is a controller (ECU) as control means constituted of a microcomputer, and an input of the controller 32 is connected to respective outputs of an outdoor air temperature sensor 33 which detects an outdoor air temperature Tam of the vehicle, an HVAC suction temperature sensor 36 which detects a temperature of the air to be sucked from the suction port 25 to the air flow passage 3, an indoor air temperature sensor 37 which detects a temperature of the air of the vehicle interior (the indoor air), an indoor air humidity sensor 38 which detects a humidity of the air of the vehicle interior, an indoor CO₂ concentration sensor 39 which detects a carbon dioxide concentration of the vehicle interior, an outlet temperature sensor 41 which detects a temperature of the air blown out from the outlet 29 to the vehicle interior, a discharge pressure sensor 42 which detects a pressure of the refrigerant discharged from the compressor 2, a discharge temperature sensor 43 which detects a temperature of the refrigerant discharged from the compressor 2, a suction pressure sensor 44 which detects a suction refrigerant pressure of the compressor 2, a radiator temperature sensor 46 which detects a temperature Tci of the radiator 4 (the temperature of the radiator 4 itself or the temperature of the air heated in the radiator 4), a radiator pressure sensor 47 which detects a refrigerant pressure of the radiator 4 (the pressure in the radiator 4 or of the refrigerant which has flowed out from the radiator 4), a heat absorber temperature sensor 48 which detects a temperature Te of the heat absorber 9 (the temperature of the heat absorber 9 itself or of the air cooled in the heat absorber 9), a heat absorber pressure sensor 49 which detects a refrigerant pressure of the heat absorber 9 (the pressure in the heat absorber 9 or of the refrigerant which has flowed out from the heat absorber 9), a solar radiation sensor 51 of, e.g., a photo sensor system to detect a solar radiation amount into the vehicle, a velocity sensor 52 to detect a moving speed (a velocity) of the vehicle, an air conditioning operating portion 53 to set the changing of the temperature or the operation mode, an outdoor heat exchanger temperature sensor 54 which detects a temperature of the outdoor heat exchanger 7, and an outdoor heat exchanger pressure sensor 56 which detects a refrigerant pressure of the outdoor heat exchanger 7.

Furthermore, the input of the controller 32 is further connected to respective outputs of a heating medium heating electric heater temperature sensor 50 which detects a temperature of the heating medium heating electric heater 35 of the heating medium circulating circuit 23, and a heating medium-air heat exchanger temperature sensor 55 which detects a temperature of the heating medium-air heat exchanger 40.

On the other hand, an output of the controller 32 is connected to the compressor 2, the outdoor blower 15, the indoor blower (the blower fan) 27, the suction changing damper 26, the air mix damper 28, the outlet changing damper 31, the outdoor expansion valve 6, the indoor expansion valve 8, the respective solenoid valves 22, 17 and 21, the circulating pump 30, the heating medium heating electric heater 35 and the evaporation capability control valve 11. Then, the controller 32 controls these components on the basis of the outputs of the respective sensors and the setting input by the air conditioning operating portion 53.

Next, description will be made as to an operation of the vehicle air conditioning device 1 of the embodiment having the above constitution. The controller 32 changes and executes respective roughly divided operation modes of a heating mode, a dehumidifying and heating mode (one of dehumidifying modes in the invention in which the controller lets the refrigerant radiate heat in at least the radiator 4 and lets the refrigerant absorb heat in the heat absorber 9), an internal cycle mode (this is also included in the dehumidifying modes), a dehumidifying and cooling mode (another dehumidifying mode in the present invention), and a cooling mode. Initially, description will be made as to a flow of the refrigerant in each operation mode.

(1) Heating Mode

When the heating mode is selected by the controller 32 or a manual operation to the air conditioning operating portion 53, the controller 32 opens the solenoid valve 21 and closes the solenoid valve 17 and the solenoid valve 22. Then, the controller operates the compressor 2 and the respective blowers 15 and 27, and the air mix damper 28 has a state of passing the air blown out from the indoor blower 27 through the heating medium-air heat exchanger 40 and the radiator 4. In consequence, a high-temperature high-pressure gas refrigerant discharged from the compressor 2 flows into the radiator 4. The air in the air flow passage 3 passes through the radiator 4, and hence the air in the air flow passage 3 heats by the heating medium-air heat exchanger 40 (when the heating medium circulating circuit 23 is operating) and then heats by the high-temperature refrigerant in the radiator 4. On the other hand, the refrigerant in the radiator 4 has the heat taken by the air and is cooled to condense and liquefy.

The refrigerant liquefied in the radiator 4 flows out from the radiator 4, then flows through the refrigerant pipe 13E to reach the outdoor expansion valve 6 in which the refrigerant is decompressed, and then flows into the outdoor heat exchanger 7. The refrigerant flowing into the outdoor heat exchanger 7 evaporates, and the heat is pumped up from the outdoor air passed by running or the outdoor blower 15 (a heat pump). Then, the low-temperature refrigerant flowing out from the outdoor heat exchanger 7 flows through the refrigerant pipe 13D and the solenoid valve 21, and flows from the refrigerant pipe 13C into the accumulator 12 to perform gas-liquid separation, and the gas refrigerant is sucked into the compressor 2, thereby repeating this circulation. The air heated in the heating medium-air heat exchanger 40 and the radiator 4 is blown out from the outlet 29, thereby performing the heating of the vehicle interior.

The controller 32 controls a number of revolution of the compressor 2 on the basis of the high pressure of the refrigerant circuit R which is detected by the discharge pressure sensor 42 or the radiator pressure sensor 47, controls a valve position of the outdoor expansion valve 6 on the basis of the temperature (the radiator temperature TCI) of the radiator 4 which is detected by the radiator temperature sensor 46, and controls a subcool degree SC of the refrigerant in an outlet of the radiator 4.

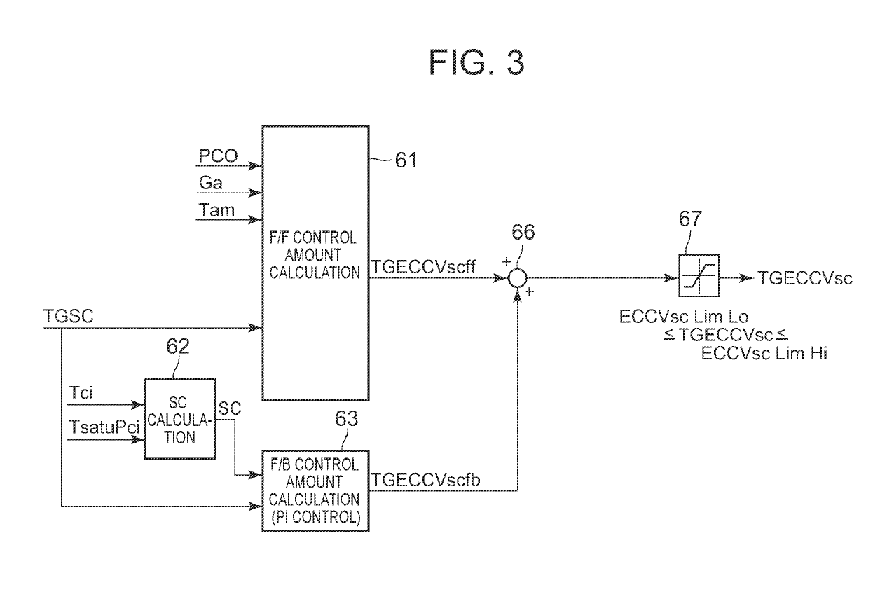

FIG. 3 is a control block diagram of the controller 32 which determines a target position (an outdoor expansion valve target position) TGECCVsc of the outdoor expansion valve 6 in the heating mode. An F/F control amount calculation section 61 of the controller 32 calculates an F/F control amount TGECCVscff of the outdoor expansion valve target position on the basis of a target subcool degree TGSC that is a target value of the subcool degree SC in the outlet of the radiator 4, an actual subcool degree SC in the outlet of the radiator 4 which is calculated from the radiator temperature Tci and a saturation temperature TsatuPci by a SC calculation section 62, a target radiator pressure PCO, a mass air volume Ga of the air flowing into the air flow passage 3, and the outdoor air temperature Tam.

Furthermore, an F/B control amount calculation section 63 calculates an F/B control amount TGECCVscfb of the outdoor expansion valve target position on the basis of the target subcool degree TGSC and the subcool degree SC by PI control with a difference e between the degrees in the embodiment. An adder 66 adds the F/B control amount TGECCVscfb calculated by the F/B control amount calculation section 63 and the F/F control amount TGECCVscff calculated by the F/F control amount calculation section 61, a limit setting section 67 attaches limits of an upper limit of controlling and a lower limit of controlling, and then the outdoor expansion valve target position TGECCVsc is determined. In the heating mode, the controller 32 finely controls the valve position of the outdoor expansion valve 6 on the basis of the outdoor expansion valve target position TGECCVsc, to control the subcool degree SC of the refrigerant in the outlet of the radiator 4 to the target subcool degree TGSC. It is to be noted that the calculation in the F/B control amount calculation section 63 is not limited to the PI control, and PID control may be executed.

(2) Dehumidifying and Heating Mode

Next, in the dehumidifying and heating mode, the controller 32 opens the solenoid valve 22 in the above state of the heating mode. In consequence, a part of the condensed refrigerant flowing through the radiator 4 and the refrigerant pipe 13E is distributed, and flows through the solenoid valve 22 to flow from the refrigerant pipes 13F and 13B through the internal heat exchanger 19, thereby reaching the indoor expansion valve 8. The refrigerant is decompressed in the indoor expansion valve 8 and then flows into the heat absorber 9 to evaporate. Water in the air blown out from the indoor blower 27 coagulates to adhere to the heat absorber 9 by a heat absorbing operation at this time, and hence the air is cooled and dehumidified.

The refrigerant evaporated in the heat absorber 9 successively flows through the evaporation capability control valve 11 and the internal heat exchanger 19 to join the refrigerant from the refrigerant pipe 13D in the refrigerant pipe 13C, and then flows through the accumulator 12 to be sucked into the compressor 2, thereby repeating this circulation. The air dehumidified in the heat absorber 9 is reheated in a process of passing the radiator 4, thereby performing the dehumidifying and heating of the vehicle interior.

The controller 32 controls the number of revolution of the compressor 2 on the basis of the high pressure of the refrigerant circuit R which is detected by the discharge pressure sensor 42 or the radiator pressure sensor 47. It is to be noted that in this dehumidifying and heating mode, the controller 32 controls the valve position of the outdoor expansion valve 6 on the basis of the temperature of the heat absorber 9 (the heat absorber temperature Te) which is detected by the heat absorber temperature sensor 48. Description will be made as to the control of the valve position of the outdoor expansion valve 6 in this dehumidifying and heating mode and the control of the evaporation capability control valve 11 later in detail.

(3) Internal Cycle Mode

Next, in the internal cycle mode, the controller 32 closes (shuts off) the outdoor expansion valve 6 in the above state of the dehumidifying and heating mode. In other words, it can be considered that this internal cycle mode is a state where the outdoor expansion valve 6 is shut off by the control of the outdoor expansion valve 6 in the dehumidifying and heating mode, and hence the internal cycle mode can be regarded as a part of the dehumidifying and heating mode.

However, the outdoor expansion valve 6 is closed, thereby obstructing inflow of the refrigerant into the outdoor heat exchanger 7, and hence all the condensed refrigerant flowing through the radiator 4 and the refrigerant pipe 13E flows through the solenoid valve 22 to the refrigerant pipe 13F. Then, the refrigerant flowing through the refrigerant pipe 13F flows from the refrigerant pipe 13B through the internal heat exchanger 19 to reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence the air is cooled and dehumidified.

The refrigerant evaporated in the heat absorber 9 flows through the evaporation capability control valve 11, the internal heat exchanger 19, the refrigerant pipe 13C and the accumulator 12 to be sucked into the compressor 2, thereby repeating this circulation. The air dehumidified in the heat absorber 9 is reheated in the process of passing the radiator 4, thereby performing the dehumidifying and heating of the vehicle interior, but in this internal cycle mode, the refrigerant circulates between the radiator 4 (heat radiation) and the heat absorber 9 (heat absorption) which are present in the air flow passage 3 on an indoor side, and hence the heat is not pumped up from the outdoor air, but the heating capability for a consumed power of the compressor 2 and additionally for a quantity of heat absorbed in the heat absorber 9 is exerted. The whole amount of the refrigerant flows through the heat absorber 9 which exerts a dehumidifying operation, and hence as compared with the above dehumidifying and heating mode, a dehumidifying capability is higher, but the heating capability lowers.

Furthermore, the controller 32 controls the number of revolution of the compressor 2 on the basis of the temperature of the heat absorber 9 or the above-mentioned high pressure of the refrigerant circuit R. At this time, the controller 32 selects a smaller compressor target number of revolution from compressor target numbers of revolution obtainable by calculations from the temperature Te of the heat absorber 9 and a high pressure Pci, to control the compressor 2.

(4) Dehumidifying and Cooling Mode

Next, in the dehumidifying and cooling mode, the controller 32 opens the solenoid valve 17 and closes the solenoid valve 21 and the solenoid valve 22. Then, the controller operates the compressor 2 and the respective blowers 15 and 27, and the air mix damper 28 has the state of passing the air blown out from the indoor blower 27 through the heating medium-air heat exchanger 40 and the radiator 4. In consequence, the high-temperature high-pressure gas refrigerant discharged from the compressor 2 flows into the radiator 4. Through the radiator 4, the air in the air flow passage 3 passes, and hence the air in the air flow passage 3 heats by the high-temperature refrigerant in the radiator 4 (the heating medium circulating circuit 40 stops), whereas the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15, to condense. The refrigerant flowing out from the outdoor heat exchanger 7 flows from the refrigerant pipe 13A through the solenoid valve 17 to successively flow into the header portion 14 and the subcooling portion 16. Here, the refrigerant is subcooled.

The refrigerant flowing out from the subcooling portion 16 of the outdoor heat exchanger 7 flows through the check valve 18 to enter the refrigerant pipe 13B, and flows through the internal heat exchanger 19 to reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence the air is cooled and dehumidified.

The refrigerant evaporated in the heat absorber 9 flows through the evaporation capability control valve 11, the internal heat exchanger 19 and the refrigerant pipe 13C to reach the accumulator 12, and flows therethrough to be sucked into the compressor 2, thereby repeating this circulation. The air cooled and dehumidified in the heat absorber 9 is reheated in the process of passing the radiator 4 (a radiation capability is lower than that during the heating), thereby performing the dehumidifying and cooling of the vehicle interior.

The controller 32 controls the number of revolution of the compressor 2 on the basis of the temperature of the heat absorber 9 which is detected by the heat absorber temperature sensor 48, also controls the valve position of the outdoor expansion valve 6 on the basis of the above-mentioned high pressure (the radiator pressure Pci) of the refrigerant circuit R, and controls the refrigerant pressure (the radiator pressure Pci) of the radiator 4. Description will be made as to the control later in detail.

(5) Cooling Mode

Next, in the cooling mode, the controller 32 fully opens the outdoor expansion valve 6 in the above state of the dehumidifying and cooling mode (the valve position is adjusted to an upper limit of controlling), and the air mix damper 28 has a state where the air does not pass through the radiator 4. In consequence, the high-temperature high-pressure gas refrigerant discharged from the compressor 2 flows into the radiator 4. The air in the air flow passage 3 does not pass through the radiator 4, the refrigerant therefore only passes the radiator, and the refrigerant flowing out from the radiator 4 flows through the refrigerant pipe 13E to reach the outdoor expansion valve 6.

At this time, the outdoor expansion valve 6 is fully open, and hence the refrigerant flows into the outdoor heat exchanger 7 as it is, in which the refrigerant is cooled by the running therein or the outdoor air passing through the outdoor blower 15, to condense and liquefy. The refrigerant flowing out from the outdoor heat exchanger 7 flows from the refrigerant pipe 13A through the solenoid valve 17 to successively flow into the header portion 14 and the subcooling portion 16. Here, the refrigerant is subcooled.

The refrigerant flowing out from the subcooling portion 16 of the outdoor heat exchanger 7 flows through the check valve 18 to enter the refrigerant pipe 13B, and flows through the internal heat exchanger 19 to reach the indoor expansion valve 8. The refrigerant is decompressed in the indoor expansion valve 8 and then flows into the heat absorber 9 to evaporate. The air blown out from the indoor blower 27 is cooled by the heat absorbing operation at this time.

The refrigerant evaporated in the heat absorber 9 flows through the evaporation capability control valve 11, the internal heat exchanger 19 and the refrigerant pipe 13C to reach the accumulator 12, and flows therethrough to be sucked into the compressor 2, thereby repeating this circulation. The air cooled and dehumidified in the heat absorber 9 does not pass the radiator 4, but is blown out from the outlet 29 to the vehicle interior, thereby performing cooling of the vehicle interior. In this cooling mode, the controller 32 controls the number of revolution of the compressor 2 on the basis of the temperature Te of the heat absorber 9 which is detected by the heat absorber temperature sensor 48.

Then, the controller 32 selects and changes the above respective operation modes in accordance with the outdoor air temperature and a target outlet temperature.

(6) Control of Outdoor Expansion Valve 6 and Evaporation Capability Control Valve 11 in Dehumidifying and Heating Mode

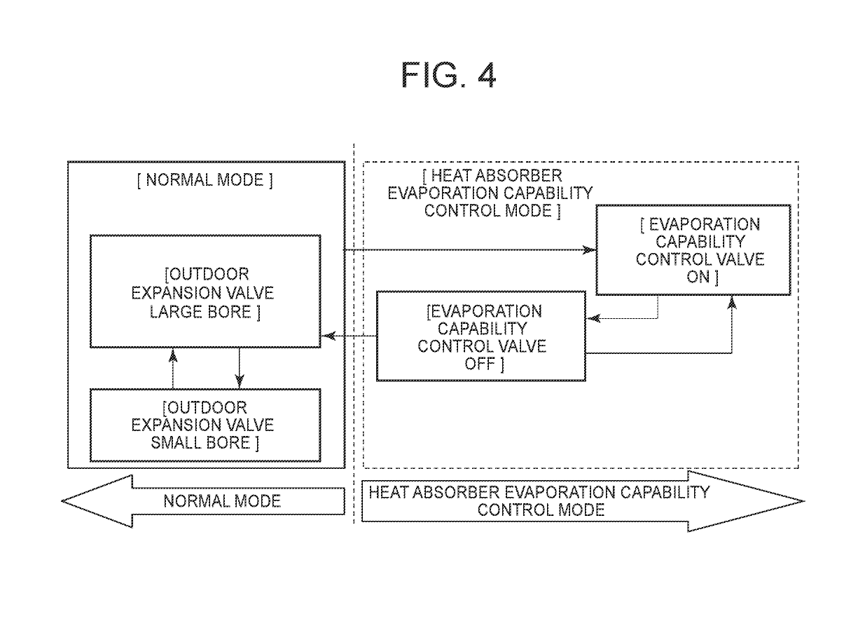

Next, description will be made as to the control of the outdoor expansion valve 6 and the evaporation capability control valve 11 in the dehumidifying and heating mode by the controller 32 with reference to FIG. 4 to FIG. 6. In the above-mentioned dehumidifying and heating mode, the controller 32 employs the heat absorber temperature Te detected by the heat absorber temperature sensor 48 as an index that is a basis of the control of the outdoor expansion valve 6, and executes simple control to compare the heat absorber temperature Te that is an actual detected value of the index with a target heat absorber temperature TEO that is its target value and to change the valve position of the outdoor expansion valve 6 from a magnitude relation between the temperatures in an enlarging direction or a reducing direction as much as a constant value.

In this case, as shown in a transition diagram of FIG. 4, the controller 32 changes and executes a normal mode by the valve position control of the outdoor expansion valve 6 and a heat absorber evaporation capability control mode by the valve position control of the evaporation capability control valve 11 in this dehumidifying and heating mode.

(6-1) Normal Mode of Dehumidifying and Heating Mode

Initially, description will be made as to the normal mode in the dehumidifying and heating mode. The controller 32 sets the valve position of the evaporation capability control valve 11 to the above-mentioned large position (OFF) in the normal mode of the dehumidifying and heating mode. Then, the controller 32 compares the heat absorber temperature Te with the target heat absorber temperature TEO, and in the embodiment, the controller adjusts the valve position of the outdoor expansion valve 6 to an upper limit (a large bore) of a control range when the heat absorber temperature Te is lower than the target heat absorber temperature TEO, and adjusts the valve position to a lower limit (a small bore) of the control range when the heat absorber temperature Te is higher than the target heat absorber temperature TEO.

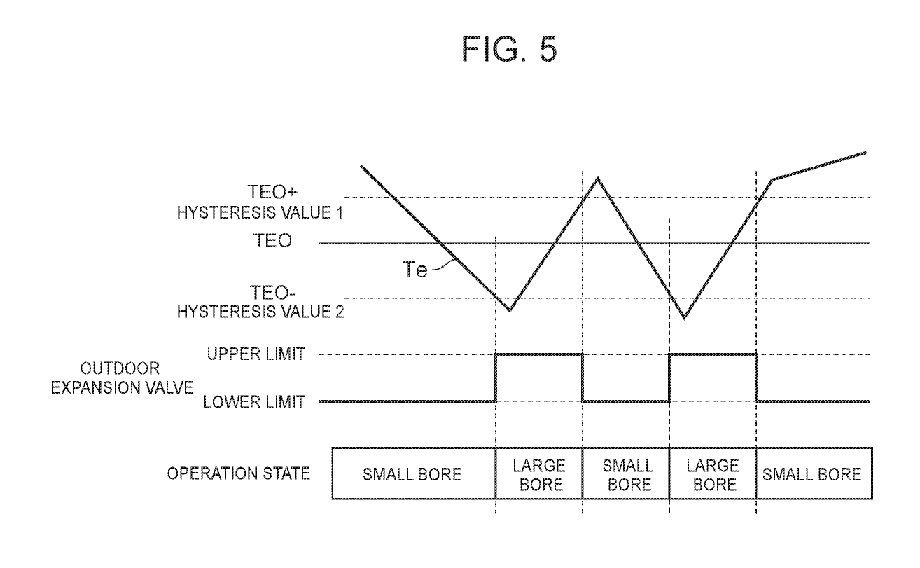

However, in actual, the controller sets predetermined hysteresis values 1 and 2 above and below the target heat absorber temperature TEO to execute the control as shown in FIG. 5 for the purpose of preventing or inhibiting control hunting. Specifically, when the heat absorber temperature Te drops to be lower than the target heat absorber temperature TEO−the hysteresis value 2 and this state continues for a predetermined time t1 (e.g., 6 seconds or the like) (corresponding to when the heat absorber temperature Te is lower than the target heat absorber temperature TEO), the controller changes the valve position of the outdoor expansion valve 6 in the enlarging direction as much as the constant value (a constant pulse number) to adjust the valve position to the upper limit (the large bore) of the control range.

Consequently, a flow rate of the refrigerant flowing through the refrigerant pipe 131 into the outdoor heat exchanger 7 increases, and a flow rate of the refrigerant flowing through the refrigerant pipe 13F to reach the heat absorber 9 decreases, and hence an amount of the refrigerant to evaporate in the heat absorber 9 decreases, and the temperature of the heat absorber 9 rises. Afterward, when the heat absorber temperature Te rises to the target heat absorber temperature TEO+the hysteresis value 1 or more and the state continues for the predetermined time t1 (corresponding to when the heat absorber temperature Te is higher than the target heat absorber temperature TEO), the controller changes the valve position of the outdoor expansion valve 6 in the reducing direction as much as the above-mentioned constant value (the constant pulse number) to adjust the valve position to the lower limit (the small bore) of the control range.

In consequence, the flow rate of the refrigerant flowing through the refrigerant pipe 131 into the outdoor heat exchanger 7 decreases, and the flow rate of the refrigerant flowing through the refrigerant pipe 13F to reach the heat absorber 9 increases, and hence the amount of the refrigerant to evaporate in the heat absorber 9 increases, and the temperature of the heat absorber 9 turns to drop. Afterward, the controller repeats this control in the normal mode, and controls the heat absorber temperature Te to the target heat absorber temperature TEO (in actual, a temperature in the vicinity of the target heat absorber temperature TEO in a range of the upper and lower hysteresis values 1 and 2 of the target heat absorber temperature TEO).

(6-2) Heat Absorber Evaporation Capability Control Mode of Dehumidifying and Heating Mode

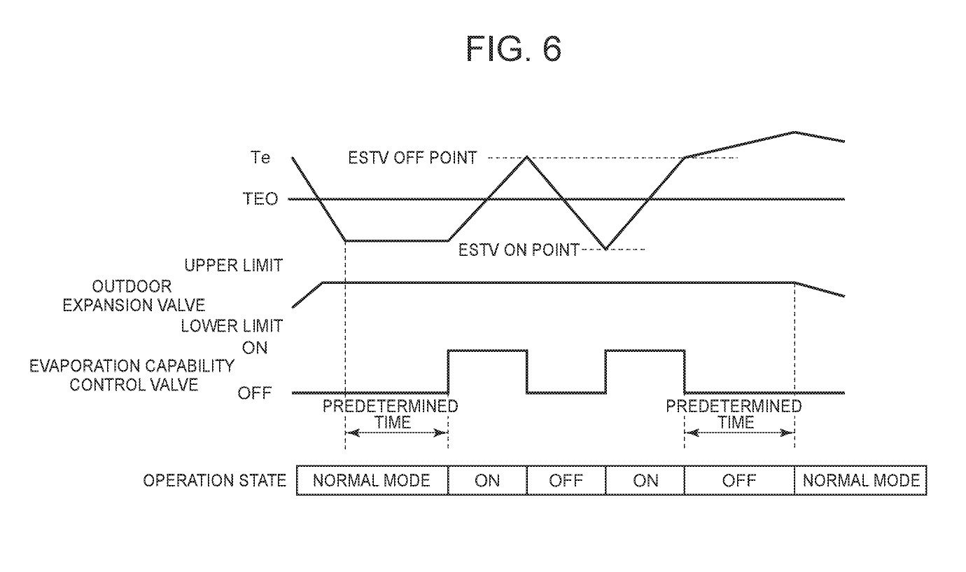

Here, the controller 32 shifts from the normal mode to the heat absorber evaporation capability control mode, when a state where the heat absorber temperature Te is lower than the target heat absorber temperature TEO continues for a predetermined time t2 (e.g., 10 seconds or the like), although the valve position of the outdoor expansion valve 6 indicates the upper limit (the large bore). FIG. 6 is a timing chart of this heat absorber evaporation capability control mode. The controller 32 initially changes the valve position of the evaporation capability control valve 11 to the above-mentioned small position (ON) in this heat absorber evaporation capability control mode. Consequently, a flow rate of the refrigerant flowing through the heat absorber 9 decreases, and hence the heat absorber temperature Te rises.

Then, when the heat absorber temperature Te rises to a predetermined OFF point (an ESTV OFF point) or more of the evaporation capability control valve 11 which is higher than the target heat absorber temperature TEO (lower than TEO+the hysteresis value 1), the controller 32 changes the valve position of the evaporation capability control valve 11 to a large position (OFF). Consequently, the flow rate of the refrigerant flowing through the heat absorber 9 increases, and hence the heat absorber temperature Te drops. Then, when the heat absorber temperature Te becomes lower than a predetermined ON point (an ESTV ON point) of the evaporation capability control valve 11 which is lower than the target heat absorber temperature TEO (higher than the TEO−the hysteresis value 2), the controller 32 changes the valve position of the evaporation capability control valve 11 again to the small position (ON).

Afterward, the controller repeats this control in the heat absorber evaporation capability control mode, and controls the heat absorber temperature Te to the target heat absorber temperature TEO (in actual, a temperature in the vicinity of the target heat absorber temperature TEO in a range between the ESTV ON point and the ESTV OFF point below and above the target heat absorber temperature TEO). Then, the controller 32 returns from the heat absorber evaporation capability control mode to the normal mode (adjusts the valve position of the outdoor expansion valve 6 to the large bore), when a state where the heat absorber temperature Te is at the above-mentioned ESTV OFF point or more continues for the predetermined time t2, although the valve position of the evaporation capability control valve 11 indicates the large position (OFF).

In this way, in the dehumidifying and heating mode, the controller 32 employs the heat absorber temperature Te as the index, and in the normal mode, the controller changes the valve position of the outdoor expansion valve 6 in the enlarging direction as much as the constant value to adjust the valve position to an upper limit of controlling (the large bore) when the actually detected heat absorber temperature Te is lower than the target heat absorber temperature TEO that is the target value of the heat absorber temperature Te, and the controller changes the valve position of the outdoor expansion valve 6 in the reducing direction as much as the constant value to adjust the valve position to a lower limit of controlling (the small bore) when the heat absorber temperature Te is higher than the target heat absorber temperature TEO. Therefore, it is possible to avoid such fine control of the valve position as in the heating mode and to avoid disadvantages such as temperature rise and durability deterioration of the outdoor expansion valve 6, while acquiring controllability of the vehicle air conditioning device 1. Furthermore, it is also possible to noticeably simplify control logic, and hence generation of the disadvantages is also inhibited.

Furthermore, the controller 32 executes the heat absorber evaporation capability control mode by the adjustment of the valve position of the evaporation capability control valve 11, when the state where the heat absorber temperature Te is lower than the target heat absorber temperature TEO continues for the predetermined time, although the valve position of the outdoor expansion valve 6 indicates the upper limit of the control range. Therefore, in the valve position control of the outdoor expansion valve 6, also when it is not possible to raise the heat absorber temperature Te, the heat absorber temperature Te can be brought close to the target heat absorber temperature TEO (the vicinity) by the evaporation capability control valve 11.

It is to be noted that in the above embodiment, the controller 32 adjusts the valve position of the outdoor expansion valve 6 to the upper limit of the control range when the heat absorber temperature Te is lower than the target heat absorber temperature TEO, and adjusts the valve position of the outdoor expansion valve 6 to the lower limit of the control range when the heat absorber temperature Te is higher than the target heat absorber temperature TEO. Consequently, it is possible to further simplify the control logic, but the controller may compare the target heat absorber temperature TEO with the heat absorber temperature Te and change the valve position of the outdoor expansion valve 6 from a magnitude relation between the temperatures in the enlarging direction or the reducing direction every constant value stepwisely in the control range. In this case, it is possible to inhibit deterioration of the controllability as much as possible.

(7) Control of Compressor 2 and Outdoor Expansion Valve 6 in Dehumidifying and Cooling Mode

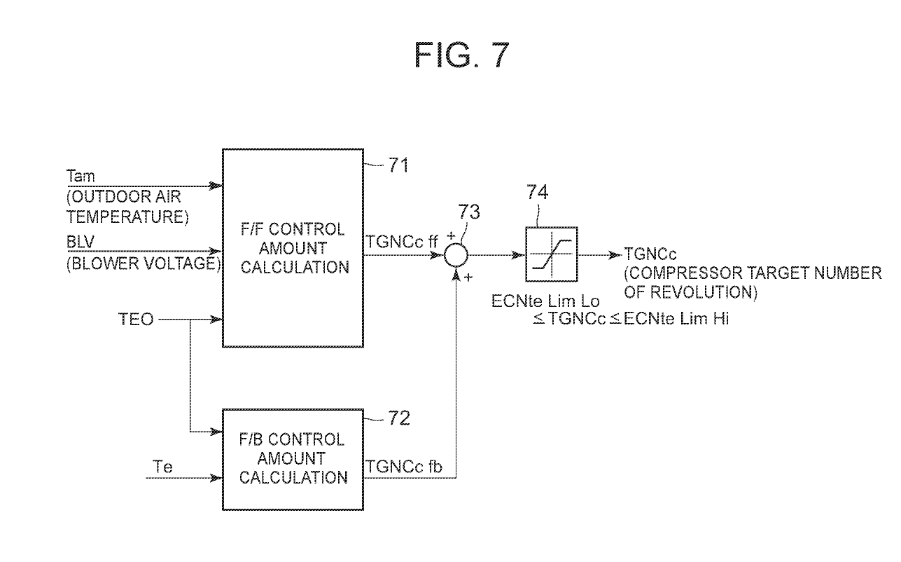

Next, description will be made as to the control of the compressor 2 and the outdoor expansion valve 6 in the dehumidifying and cooling mode by the controller 32 with reference to FIG. 7 to FIG. 10. FIG. 7 is a control block diagram of the controller 32 which determines a target number of revolution of the compressor 2 (the compressor target number of revolution) TGNCc for the above-mentioned cooling mode and dehumidifying and cooling mode (an after-mentioned normal mode). An F/F control amount calculation section 71 of the controller 32 in FIG. 7 calculates an F/F control amount TGNCcff of the compressor target number of revolution on the basis of the outdoor air temperature Tam, a blower voltage BLV and the target heat absorber temperature TEO that is the target value of the temperature of the heat absorber 9.

Furthermore, an F/B control amount calculation section 72 calculates an F/B control amount TGNCcfb of the compressor target number of revolution on the basis of the target heat absorber temperature TEO and the heat absorber temperature Te (the PI control in the embodiment). Then, an adder 73 adds the F/F control amount TGNCcff calculated by the F/F control amount calculation section 71 and the F/B control amount TGNCcfb calculated by the F/B control amount calculation section 72, a limit setting section 74 attaches limits of an upper limit of controlling and a lower limit of controlling, and then the compressor target number of revolution TGNCc is determined. In the cooling mode and the normal mode of the dehumidifying and cooling mode, the controller 32 controls the number of revolution of the compressor 2 on the basis of the compressor target number of revolution TGNCc.

Furthermore, in the dehumidifying and cooling mode, the controller 32 employs the radiator pressure Pci detected by the radiator pressure sensor 47 as the index that is the basis of the control of the outdoor expansion valve 6, and executes simple control to compare the radiator pressure Pci that is the actual detected value of the index with the target radiator pressure PCO that is its target value and to change the valve position of the outdoor expansion valve 6 from a magnitude relation between the pressures in the enlarging direction or the reducing direction as much as the constant value.

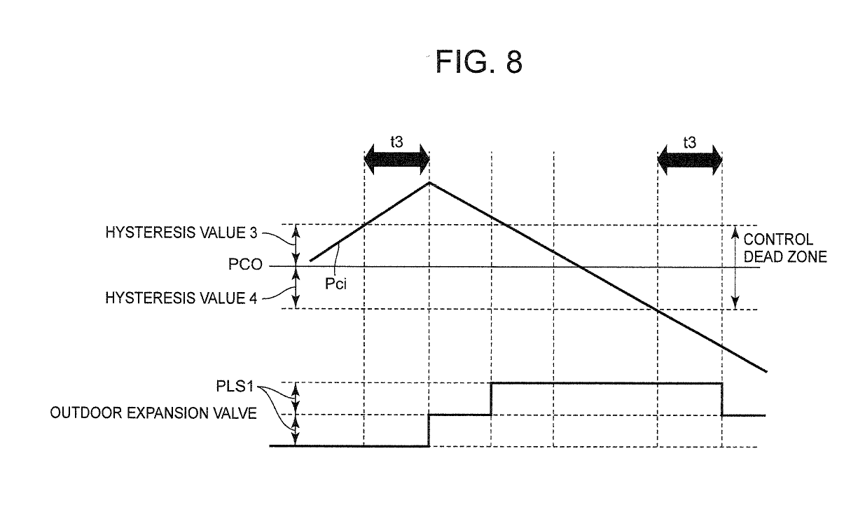

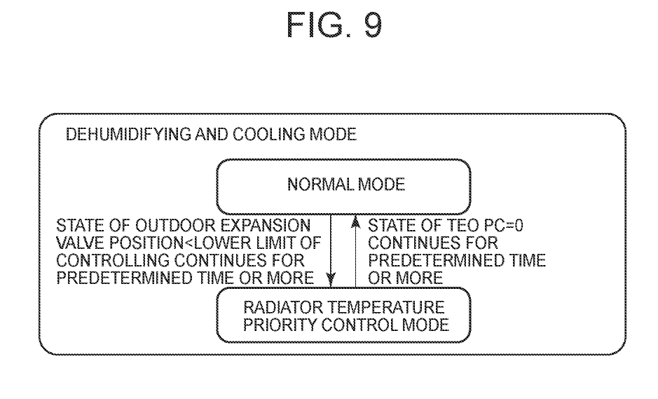

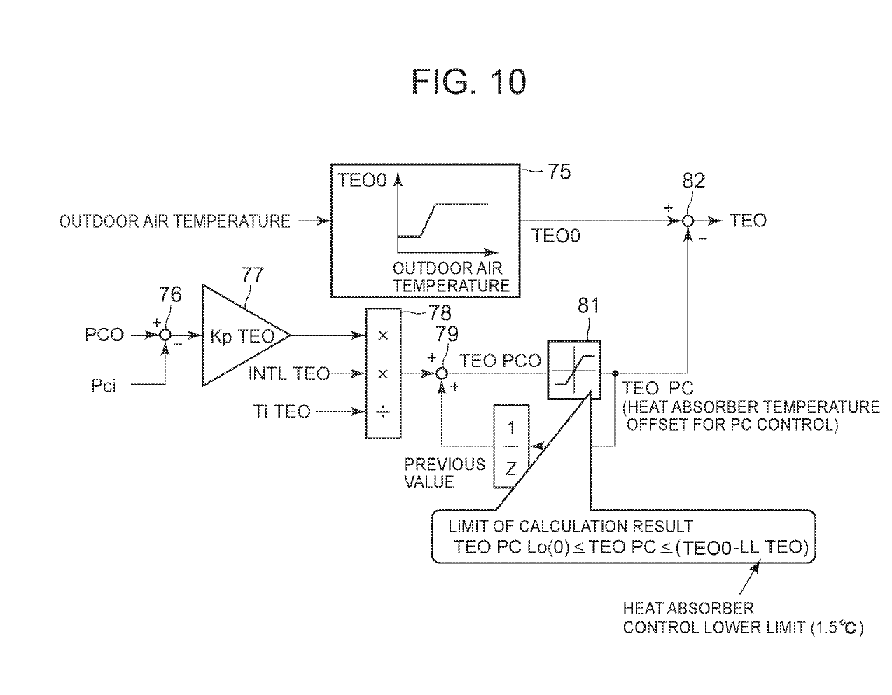

In this case, in this dehumidifying and cooling mode, the controller 32 changes and executes the normal mode by the valve position control of the outdoor expansion valve 6 shown in the timing chart of FIG. 8 and a radiator temperature priority control mode by the number of revolution of the compressor 2 shown in FIG. 9 and FIG. 10.

(7-1) Normal Mode of Dehumidifying and Cooling Mode

Initially, description will be made as to the normal mode of the dehumidifying and cooling mode. In the normal mode of the dehumidifying and cooling mode, the controller 32 controls the number of revolution of the compressor 2 as described above (FIG. 7). On the other hand, the controller 32 compares the radiator pressure Pci with the target radiator pressure PCO, and in the embodiment, the controller changes the valve position of the outdoor expansion valve 6 in the reducing direction as much as a constant value PLS1 (the constant pulse number, e.g., 15 or the like) when the radiator pressure Pci is lower than the target radiator pressure PCO, and the controller changes the valve position of the outdoor expansion valve 6 in the enlarging direction as much as the constant value PLS1 when the radiator pressure Pci is higher than the target radiator pressure PCO.

However, in actual, the controller sets predetermined hysteresis values 3 and 4 above and below the target radiator pressure PCO to execute the control as shown in FIG. 8 for the purpose of preventing or inhibiting the control hunting. Specifically, when the radiator pressure Pci rises to be higher than the target radiator pressure PCO+the hysteresis value 3 and this state continues for a predetermined time t3 (e.g., 5 seconds or the like) (corresponding to when the radiator pressure Pci is higher than the target radiator pressure PCO), the controller changes the valve position of the outdoor expansion valve 6 in the enlarging direction as much as the constant value PLS1 to enlarge the valve position.

Consequently, the refrigerant easily flows through the refrigerant pipe 131 into the outdoor heat exchanger 7, and hence the radiator pressure Pci turns to drop, but when the radiator pressure Pci is still higher than the target radiator pressure PCO+the hysteresis value 3 continuously for a further predetermined time t3, the controller changes the valve position of the outdoor expansion valve 6 in the enlarging direction as much as the constant value PLS1 to further enlarge the valve position. When due to such a stepwise enlargement of the valve position, the radiator pressure Pci lowers down to the target radiator pressure PCO+the hysteresis value 3 or less, the controller 32 maintains the valve position at this time.

Afterward, when the radiator pressure Pci lowers to be lower than the target radiator pressure PCO−the hysteresis value 4 and this state continues for the predetermined time t3 (corresponding to when the radiator pressure Pci is lower than the target radiator pressure PCO), the controller changes the valve position of the outdoor expansion valve 6 in the reducing direction as much as the constant value PLS1 mentioned above to reduce the valve position.

Consequently, the refrigerant is hard to flow through the refrigerant pipe 131 into the outdoor heat exchanger 7, and hence the radiator pressure Pci turns to rise. Afterward, the controller repeats such stepwise enlargement and reduction of the valve position between the upper limit and the lower limit of the control range (within the control range) of the outdoor expansion valve 6, and controls the radiator pressure Pci to the target radiator pressure PCO (in actual, a pressure in the vicinity of the target radiator pressure PCO in the range of the upper and lower hysteresis values 3 and 4 of the target radiator pressure PCO).

(7-2) Radiator Temperature Priority Control Mode of Dehumidifying and Cooling Mode

Here, the controller 32 shifts from the normal mode to the radiator temperature priority control mode, when a state where the radiator pressure Pci is lower than the target radiator pressure PCO−the hysteresis value 4 continues for a predetermined time t4 (e.g., 10 seconds or the like), for example, although the valve position of the outdoor expansion valve 6 is reduced to the lower limit of the control range by such stepwise valve position control. In this radiator temperature priority control mode, the controller 32 lowers the target heat absorber temperature TEO to increase the number of revolution of the compressor 2, increases a capability of the compressor 2 to raise the high pressure, and raises the radiator pressure Pci toward the target radiator pressure PCO.

FIG. 9 shows mode change control between the normal mode and the radiator temperature priority control mode in the dehumidifying and cooling mode. The controller 32 shifts to the radiator temperature priority control mode when a state where the valve position of the outdoor expansion valve 6 is lower than the lower limit of the control range continues for the predetermined time t4 or more as described above during execution of the normal mode (it can be considered that this is a mode to place priority on the heat absorber temperature) of the dehumidifying and cooling mode.

FIG. 10 shows one example of a control block diagram of the controller 32 in this radiator temperature priority control mode. Specifically, reference numeral 75 of FIG. 10 denotes a data table of a basic target heat absorber temperature TEOO, and this table is predetermined corresponding to the outdoor air temperature Tam. It is to be noted that the basic target heat absorber temperature TEO0 is a heat absorber temperature to obtain a humidity required in the environment of the outdoor air temperature. In the above-mentioned normal mode, the target heat absorber temperature TEO is determined on the basis of the data table 75, but in this radiator temperature priority control mode, the controller 32 adds an offset on the basis of an integrated value of a difference between the target radiator pressure PCO and the radiator pressure Pci.

That is, the target radiator pressure PCO and the radiator pressure Pci obtainable from the radiator pressure sensor 47 are input into a subtractor 76, and the difference e is amplified by an amplifier 77 to be input into a calculator 78. The calculator 78 performs integration of a heat absorber temperature offset for an integration time in a predetermined integration period, and an adder 79 adds the previous value to calculate an integrated value TEOPCO of the heat absorber temperature offset. Then, a limit setting section 81 attaches limits of an upper limit of controlling and a lower limit of controlling, and then a heat absorber temperature offset TEOPC is determined.

A subtractor 82 subtracts the heat absorber temperature offset TEOPC from the basic target heat absorber temperature TEOO, and the target heat absorber temperature TEO is determined. Therefore, the target heat absorber temperature TEO is lower than in the normal mode as much as the heat absorber temperature offset TEOPC, the compressor target number of revolution TGNCc of the compressor 2 thus increases, the number of revolution of the compressor 2 increases, the capability of the compressor 2 increases to raise the high pressure, and the radiator pressure Pci rises so that the required radiator pressure Pci is obtainable.

It is to be noted that the limit setting section 81 limits the heat absorber temperature offset TEOPC to a range where the heat absorber 9 is not frosted. On the other hand, when a state where the heat absorber temperature offset TEOPC mentioned above is zero continues for a predetermined time t5 or more in this radiator temperature priority control mode, the controller 32 returns from the radiator temperature priority control mode to the normal mode.

Thus, in the dehumidifying and cooling mode, the controller 32 employs the radiator pressure Pci as the index, changes the valve position of the outdoor expansion valve 6 in the reducing direction as much as the constant value when the actually detected radiator pressure Pci is lower than the target radiator pressure PCO that is the target value of the radiator pressure Pci, and changes the valve position of the outdoor expansion valve 6 in the enlarging direction as much as the constant value when the radiator pressure Pci is higher than the target radiator pressure PCO, and hence it is similarly possible to avoid such fine control of the valve position as in the heating mode and to avoid disadvantages such as the temperature rise and durability deterioration of the outdoor expansion valve 6, while acquiring the controllability of the vehicle air conditioning device 1. Furthermore, it is also possible to noticeably simplify the control logic, and hence the generation of the disadvantages is also inhibited.

Furthermore, the controller 32 compares the target radiator pressure PCO with the radiator pressure Pci, and changes the valve position of the outdoor expansion valve 6 from the magnitude relation between the pressures in the enlarging direction or the reducing direction stepwisely in the control range, and hence it is possible to inhibit the deterioration of the controllability as much as possible.

Additionally, the controller 32 executes the radiator temperature priority control mode to increase the capability of the compressor 2, when the state where the radiator pressure Pci is lower than the target radiator pressure PCO continues for the predetermined time, although the valve position of the outdoor expansion valve 6 indicates the lower limit of the control range. Therefore, also when it is not possible to raise the radiator pressure Pci with the outdoor expansion valve 6, the controller increases the capability of the compressor 2 to raise the radiator pressure Pci in the radiator temperature priority control mode, and hence it is possible to bring the radiator pressure close to the target radiator pressure PCO (or the vicinity).

It is to be noted that each hysteresis value and each predetermined time (the operation standby time) are set in the controller 32 to inhibit the control hunting of the outdoor expansion valve 6 as described above, but the hysteresis value and operation standby time as well as an operating width of the outdoor expansion valve 6 are determined in a range where abnormal heating of a coil of the outdoor expansion valve 6 is inhibited and where the controllability is not obstructed. Consequently, it is possible to securely avoid the abnormal heating of the outdoor expansion valve 6 while acquiring the controllability.

Furthermore, in the above embodiment, the present invention is applied to the vehicle air conditioning device 1 which changes and executes the respective operation modes of the heating mode, the dehumidifying and heating mode, the internal cycle mode, the dehumidifying and cooling mode, and the cooling mode, but the present invention is not limited to the embodiment, and the present invention may be applied to another device that does not distinguish dehumidifying and heating from dehumidifying and cooling but executes the heating mode and the dehumidifying mode (a flow of the dehumidifying and heating or the dehumidifying and cooling). Additionally, the constitution or each numeric value of the refrigerant circuit described above in the embodiment does not restrict the present invention, and is changeable without departing from the gist of the present invention.

### DESCRIPTION OF REFERENCE NUMERALS

1 vehicle air conditioning device

2 compressor

3 air flow passage

4 radiator

6 outdoor expansion valve

7 outdoor heat exchanger

8 indoor expansion valve

9 heat absorber

32 controller (control means)

47 radiator pressure sensor

48 heat absorber temperature sensor

R refrigerant circuit

1. A vehicle air conditioning device which comprises
a compressor to compress a refrigerant,
an air flow passage through which air to be supplied to a vehicle interior flows,
a radiator disposed in the air flow passage to let the refrigerant radiate heat,
a heat absorber disposed in the air flow passage to let the refrigerant absorb heat,
an outdoor heat exchanger disposed outside the vehicle interior to let the refrigerant radiate heat or absorb heat,
an outdoor expansion valve to decompress the refrigerant flowing out from the radiator and let the refrigerant flow into the outdoor heat exchanger, and
a control means;
so that the control means is configured to change and execute at least a heating mode in which the control means lets the refrigerant discharged from the compressor radiate heat in the radiator,
decompresses the refrigerant from which the heat has been radiated, and then lets the refrigerant absorb heat in the outdoor heat exchanger, and
at least a dehumidifying mode in which the control means lets the refrigerant discharged from the compressor radiate heat in the radiator, decompresses the refrigerant from which the heat has been radiated, and then lets the refrigerant absorb heat in the heat absorber;
wherein in the dehumidifying mode, the control means executes simple control to compare a target value of an index that is a basis of control of the outdoor expansion valve with an actual detected value and to change a valve position of the outdoor expansion valve from a magnitude relation between the values in an enlarging direction or a reducing direction as much as a constant value.

2. The vehicle air conditioning device according to claim 1,
wherein in the heating mode, the control means calculates a control amount of the outdoor expansion valve on the basis of a target subcool degree that is a target value of a subcool degree of the refrigerant in an outlet of the radiator and an actual subcool degree, and controls the subcool degree to the target subcool degree.

3. The vehicle air conditioning device according to claim 1,
wherein the dehumidifying mode has a dehumidifying and heating mode in which the control means lets the refrigerant discharged from the compressor radiate heat in the radiator, distributes the refrigerant from which the heat has been radiated, decompresses one refrigerant and then lets the refrigerant absorb heat in the heat absorber, and decompresses the other refrigerant by the outdoor expansion valve and then lets the refrigerant absorb heat in the outdoor heat exchanger, and
in the dehumidifying and heating mode, the control means employs a heat absorber temperature as the index, changes the valve position of the outdoor expansion valve in the enlarging direction as much as the constant value when an actually detected heat absorber temperature is lower than a target heat absorber temperature that is a target value of the heat absorber temperature, and changes the valve position of the outdoor expansion valve in the reducing direction as much as the constant value when the heat absorber temperature is higher than the target heat absorber temperature.

4. The vehicle air conditioning device according to claim 3,
wherein the control means adjusts the valve position of the outdoor expansion valve to an upper limit of a control range when the heat absorber temperature is lower than the target heat absorber temperature, and adjusts the valve position of the outdoor expansion valve to a lower limit of the control range when the heat absorber temperature is higher than the target heat absorber temperature.

5. The vehicle air conditioning device according to claim 3,
wherein the control means compares the target heat absorber temperature with the heat absorber temperature, and changes the valve position of the outdoor expansion valve from a magnitude relation between the temperatures in the enlarging direction or the reducing direction stepwisely in the control range.

6. The vehicle air conditioning device according to claim 3, comprising:
an evaporation capability control valve disposed on a refrigerant outlet side of the heat absorber to adjust an evaporation capability of the refrigerant in the heat absorber,
wherein the control means executes heat absorber evaporation capability control by adjustment of a valve position of the evaporation capability control valve, when a state where the heat absorber temperature is lower than the target heat absorber temperature continues for a predetermined time, although the valve position of the outdoor expansion valve indicates the upper limit of the control range.

7. The vehicle air conditioning device according to claim 1,
wherein the dehumidifying mode has a dehumidifying and cooling mode in which the control means lets the refrigerant discharged from the compressor radiate heat in the radiator and the outdoor heat exchanger, decompresses the refrigerant from which the heat has been radiated, and then lets the refrigerant absorb heat in the heat absorber, and
in the dehumidifying and cooling mode, the control means employs a radiator pressure as the index, changes the valve position of the outdoor expansion valve in the reducing direction as much as the constant value when an actually detected radiator pressure is lower than a target radiator pressure that is a target value of the radiator pressure, and changes the valve position of the outdoor expansion valve in the enlarging direction as much as the constant value when the radiator pressure is higher than the target radiator pressure.

8. The vehicle air conditioning device according to claim 7,
wherein the control means compares the target radiator pressure with the radiator pressure, and changes the valve position of the outdoor expansion valve from a magnitude relation between the pressures in the enlarging direction or the reducing direction stepwisely in the control range.

9. The vehicle air conditioning device according to claim 7,
wherein in the dehumidifying and cooling mode, the control means controls a capability of the compressor on the basis of the heat absorber temperature, and
executes radiator temperature priority control to increase the capability of the compressor, when a state where the radiator pressure is lower than the target radiator pressure continues for a predetermined time, although the valve position of the outdoor expansion valve indicates the lower limit of the control range.

10. The vehicle air conditioning device according to claim 1,
wherein the control means determines an operating width and an operation standby time of the outdoor expansion valve in a range to inhibit control hunting of the outdoor expansion valve and to prevent abnormal heating.
